(19) United States
(12) Patent Application Publication
(10) Pub. No.: US 2009/0022201 A1
(43) Pub. Date: Jan. 22, 2009

(54) Alkali-Vapor Laser with Transverse Pumping

(75) Inventors: William F. Krupke, Pleasanton, CA (US); Jason Stuart Zweiback, Alamo, CA (US); Alexander A. Betin, Manhattan Beach, CA (US)

Correspondence Address: FITCH EVEN TABIN AND FLANNERY, 120 SOUTH LA SALLE STREET, SUITE 1600, CHICAGO, IL, 60603-3406, US

(73) Assignee: GENERAL ATOMICS, San Diego, CA (US)

(21) Appl. No.: 12/122,524

(22) Filed: May 16, 2008

Related U.S. Application Data
(60) Provisional application No. 60/938,630, filed on May 17, 2007.

(51) Int. Cl. H01S 3/0933; H01S 3/09

(52) U.S. Cl. 372/75; 372/90

(57) ABSTRACT

Alkali-vapor laser and related methods of lasing are described herein. In some embodiments, a diode-pumped gas-vapor laser is provided that can be scaled to high power. For example, in one embodiment, a triply-transverse configuration of a diode-pumped-alkali-laser (DPAL) is disclosed in which alkali-buffer gain medium is flowed through an laser chamber (for example, configured as an optical resonator or amplifier) whose optical axis is nominally transverse to the flow direction, and whose pump array radiation is propagated into the alkali-buffer gain medium in a direction nominally transverse to both the direction of gain medium flow and the direction of the optical axis.

This application claims the benefit of U.S. Provisional Application No. 60/938,630, filed May 17, 2007, which is incorporated in its entirety herein by reference.

### BACKGROUND OF THE INVENTION

1. Field of the Invention

The present invention relates generally to diode pumped lasers, and more specifically to diode-pumped alkali lasers (DPALs).

2. Discussion of the Related Art

There is a continuing, even accelerating, need for lasers with more than tens of kilowatts with excellent beam quality (i.e., near diffraction limited). Scaling the output power of diode pumped solid state lasers (DPSSLs) into this regime and beyond, while maintaining excellent beam quality, has proven to be problematic mainly due to thermally-induced distortions produced in the solid state laser gain medium under strong pump excitation conditions. This limitation of DPSSL scaling arises, in part, due to the relatively large quantum energy defect values (difference between the pump and laser output photon energies). This quantity gives the minimum amount of waste heat deposited in the solid state gain medium for each laser photon extracted. Quantum defect values typical for solid state gain media are: 1064 nm Nd:YAG laser—0.27; 1030 nm Yb:YAG laser—0.09. Additionally, since the waste heat deposited in the solid state gain medium is removed from the interior by thermal conduction to one or more exterior surfaces of the solid state gain element, thermal gradients are set up in the gain element. In turn, these thermal gradients often lead to deleterious optical distortion of the gain element, including thermal focusing, stress-birefringence, and even mechanical rupture. All of these effects tend to become more severe as one attempts to scale the output power from a single solid state gain element (e.g., a single, coherent aperture).

To overcome these intrinsic limitations of solid state lasers, Krupke invented a new class of lasers, the diode-pumped alkali laser (DPAL), such as described in U.S. Pat. No. 6,643,311, U.S. Pat. No. 7,061,958 and U.S. Pat. No. 7,061,960, all of which are incorporated herein by reference. In a DPAL, the gain medium comprises mixture of an alkali atomic vapor and at least one buffer gas, typically that of a rare gas and/or a small hydrocarbon molecule. This class of laser gain media gives rise to lasers emitting at wavelengths of 895 nm (Cs, cesium), 795 nm (Rb, rubidium), and 770 nm (K, potassium). The comparative quantum defect values for these DPALs are: Cs-0.047; Rb-0.019; K-0.0044, values providing significant improvements compared to the solid state gain media values given above.

Additionally, because DPAL gain media are low-density gas-vapor phase media no thermally-induced stress birefringence is generated in the medium, even in the presence of thermal gradients; additionally, mechanical rupture of the medium cannot occur. These are significant further advantages of DPAL gain media over their DPSSL solid state counterparts.

In preferred embodiments and by way of example, referring to FIG. 1, U.S. Pat. No. 6,643,311 describes a DPAL in which the alkali-buffer vapor-gas gain medium is held statically with a containment cell 3 having windows 5 and 6, the containment cell is disposed between the end mirrors 4 and 5 (window 5 is also a mirror) of an optical resonator, and the gain medium is pumped by a diode array 1 through lens 2 nominally in a direction parallel the optical axis of the optical resonator though one of the resonator end mirrors 5 which also acts as a window (so-called “end-pumping configuration). According to FIG. 2, U.S. Pat. No. 6,643,311 also describes a variation which includes a thin film polarizer 13 between the diode array 1 and the gain cell 3. This configuration forms a laser cavity between the highly reflecting mirror 4 and an output coupling mirror 14 (at laser wavelengths). By way of further example, according to FIG. 3, U.S. Pat. No. 6,643,311 also describes a DPAL in which a 2-D laser diode pump array 19 is coupled into the gain cell 3 using a hollow lens-duct 18. An unstable laser cavity is formed by a dot-mirror 20 placed in the center of a window 15, and curved mirror 17, also serving to close the gain cell. An anti-reflection coating is placed on the window 15 in the annular region surrounding the high-reflectance dot mirror 20. Pump radiation is coupled into the gain cell 3 in this annular region and propagates through the cell 3 reflecting from a mirror coating placed on the outer barrel of the transparent-walled cell. To date, all published works on DPALs have utilized the “end-pumped” configuration. For example, see the following publications, all of which are incorporated herein by reference: Krupke et al., “Resonance Transition 795 nm Rubidium Laser”, Optics Lett., 28, 2336-2338 (2003); Zhdanov et al. “Highly Efficient Optically Pumped Cesium Vapor Laser”, Opt. Communications, 260, 696-698 (2006); Zhdanov et al, “Optically Pumped Potassium Laser”, Opt. Communications, 270, 353-355 (2007); Ehrenreich et al., “Diode Pumped Cesium Laser”, Electronics Lett., 41, 47-48 (2205); Page et al., “Multimode diode pumped gas (alkali vapor) laser”, Opt. Lett., 31, 353-355 (2006); and Wang et al., “Cesium vapor laser pumped by a volume Bragg grating coupled quasi-continuous wave laser diode array, Appl. Phys. Lett, 88, 141112 (2006).

Power scaling of end-pumped DPALs.

The geometric cell forms adopted in these end-pumped designs are typically circularly-symmetric capillaries or rectangular waveguides. When the laser gain medium is held statically in the end-pumped cells, one of the transverse dimensions of the cell (either radius of a capillary; or height of a waveguide) is kept quite small (<few millimeters). This is done so that waste heat in the medium is conducted to the near-by cell wall via thermal conduction in the gain medium, keeping the gas medium temperature rise to adequately low value. Scaling end-pumped DPALs to ever higher power is achieved by, at some power level, abandoning the use of a capillary type cell and adopting a waveguide type cell of increasing guide width (i.e. increased end area of the waveguide by making it wider). This approach to power scaling to ever higher values is viable until, among other things, the rectangular waveguide end-aspect ratio (width to height) becomes too large (as limited by mechanical, thermal and/or optical considerations).

### SUMMARY OF THE INVENTION

Several embodiments of the invention advantageously address the needs above as well as other needs by providing embodiments of a gas-vapor laser and related methods of lasing.

In one embodiment, the invention can be characterized as an alkali vapor laser, comprising: a laser chamber having a volume formed therein; a gain medium flowing through said volume in a direction substantially transverse to an optical axis of said volume, said gain medium comprising a mixture of at least one buffer gas and said alkali atomic vapor, said alkali atomic vapor having a D₁ transition at wavelength λ₁ and a D₂ transition at wavelength λ₂, wherein said at least one buffer gas has the dual purpose of collisionally broadening said D₂ transition and collisionally transferring excitation energy from the upper level of said D₂ transition to the upper level of said D₁ transition at a rate larger than the radiative decay rate of either of these levels. The laser also comprises a pump laser, emitting at a wavelength substantially matching the wavelength λ₂ of said D₂ transition, with an emission spectral width of at least 0.01 nm (FWHM) for optically pumping said gain medium at the wavelength λ₂ of said D₂ transition of said alkali atomic vapor, including optical pumping in the Lorentzian spectral wings of said D₂ transition, emitting laser emission output at wavelength λ₁; said pump laser propagating its pump radiation into said gain medium in a direction substantially transverse to the optical axis of said volume and also substantially transverse to the flow direction of said gain medium.

In another embodiment, the invention can be characterized as a method of lasing comprising: flowing an alkali-buffer vapor-gas gain medium through a volume of a laser chamber transverse to an optical axis of the chamber; pumping the flowing gain medium transversely to a flow direction and transversely to the optical axis of the chamber, producing optical gain in the vapor-gas gain medium; and extracting laser output power in a direction parallel to the optical axis of the chamber, and in a direction transverse to the flow direction and the direction of optical pumping.

In a further embodiment, the invention may be characterized as a laser device comprising: a laser chamber having a volume formed therein; a gain medium within the volume and comprising a gas and vapor mixture; and a pump source oriented to side pump optical pump radiation along a pump direction into the volume. Responsive to the optical pump radiation, a laser emission from the gain medium passes through the volume along a laser axis.

In yet another embodiment, the invention may be characterized as a method of lasing comprising: pumping a gain medium within a volume of a laser chamber with optical pump radiation along a pump direction in a side-pumping configuration, the gain medium comprising a gas and vapor mixture; producing optical gain in the gain medium; and extracting laser output power in a direction parallel to an optical axis of the chamber.

In a further embodiment, the invention may be characterized as a laser device comprising: a laser chamber having a volume formed therein; a gain medium within the volume and comprising a gas and vapor mixture; and a pump source oriented to provide optical pump radiation along a pump direction into the volume. Responsive to the optical pump radiation, a laser emission from the gain medium passes through the volume along a laser axis. The laser emission has a power of at least 1 kW and up to 5 MW with a beam quality having an M² value of less than 5.

In yet another embodiment, the invention may be characterized as a laser device comprising: a laser chamber having a volume formed therein; a gain medium within the volume and comprising a gas and vapor mixture; and a pump source oriented to provide optical pump radiation along a pump direction into the volume. Responsive to the optical pump radiation, a laser emission from the gain medium passes through the volume along a laser axis. The laser emission exits the laser chamber via a surface of the laser chamber, the laser emission having an output area at the surface of at least 0.1 cm² and up to 500 cm² and the laser emission having a beam quality having an M² value of less than 5.

In a further embodiment, the invention may be characterized as a laser device comprising: a laser chamber having a volume formed therein; a gain medium within the volume and comprising a gas and vapor mixture; and a pump source oriented to provide optical pump radiation along a pump direction into the volume. Responsive to the optical pump radiation, a laser emission from the gain medium passes through the volume along a laser axis. The pump source provides the optical pump radiation having a pump flux of less than 20 kW/cm² and the laser emission has a beam quality having an M² value of less than 5.

### BRIEF DESCRIPTION OF THE DRAWINGS

Various other objects, features and attendant advantages of the embodiments of the present invention will become fully appreciated as the same becomes better understood when considered in conjunction with the accompanying drawings.

FIGS. 1-3 illustrate conventional end-pumped diode-pumped alkali lasers (DPALs).

FIG. 4 illustrates a configuration for a diode-pumped gas-vapor laser, such as a DPAL, in which a pump radiation propagation direction, an optical resonator optical axis, and a flow direction of the alkali-buffer vapor-gas medium are triply transverse to one another in accordance with several embodiments.

FIG. 5 illustrates a configuration for a diode-pumped gas-vapor laser, such as a DPAL, in which the pump radiation is provided by two separate diode arrays, each of whose radiation propagation direction is transverse to the optical resonator optical axis and the flow direction of the alkali-buffer vapor-gas medium in accordance with several embodiments.

FIG. 6 is a perspective view of a laser device in accordance with several embodiments.

FIG. 7 is a top cutaway view of one embodiment of the laser device of FIG. 6 additionally illustrating a volume within the chamber and mirrors.

FIG. 8 is a side cutaway view of one embodiment of the laser chamber of FIG. 6 which further illustrates pump coupling optics.

FIG. 9 illustrates the basic energy level scheme of the DPAL class of lasers according to some embodiments.

FIG. 10 is a laser device which is pumped on one side with a mirror reflecting transmitted pump radiation back into the chamber in accordance with one embodiment.

FIG. 11 is one embodiment of the laser device of FIG. 7 where an entrance coupler to the laser chamber includes a flow conditioner according to one embodiment.

FIG. 12 is a side end view of one embodiment of the laser device of FIGS. 6-8 illustrating one embodiment of pump coupling optics.

FIG. 13 is an illustration of the laser device of FIGS. 6-8 configured as a laser amplifier according to several embodiments.

FIG. 14 is a laser device in which the gas-vapor medium is static and does not flow through the laser chamber according to several embodiments.

FIG. 15 is a laser device in which the gas-vapor gain medium flows about a laser axis according to several embodiments.

FIG. 16 is a laser device in which a direction of diode side-pumping is along a same axis as the direction of gain medium flow according to several embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention

### DETAILED DESCRIPTION OF THE INVENTION

The following description is not to be taken in a limiting sense, but is made merely for the purpose of describing the general principles of exemplary embodiments. The scope of the invention should be determined with reference to the claims.

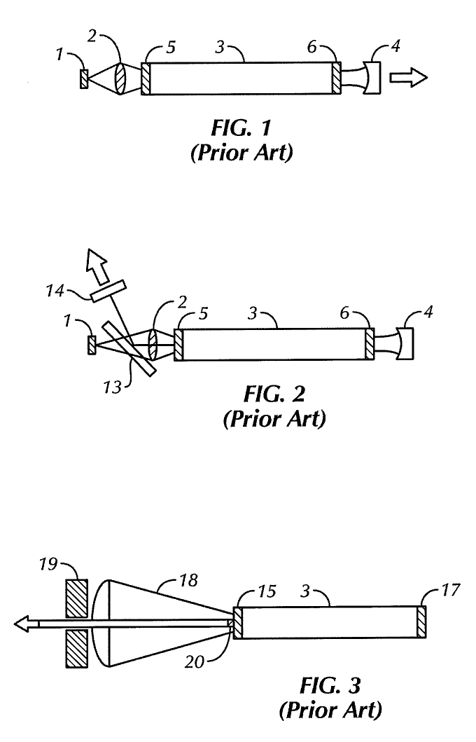

While diode-pumped alkali lasers (DPALs) in the end pumped configuration as described earlier with references to FIGS. 1-3 are known, there are a number of limitations in scaling the output power of a DPAL utilizing the end-pumped configuration, especially while retaining high beam quality.

First, the relatively small separation of the DPAL pump and output wavelengths (Cs: 43 nm; Rb: 15 nm; K: 4 nm) makes it extremely difficult to fabricate low-loss dichroic resonator end mirrors, through which to transmit pump radiation into the DPAL, and which serves as a relatively high reflectivity laser resonator mirror at the laser output wavelength.

Second, all of the diode pump radiation is concentrated into a relatively small end-area of the optical resonator. Additionally, the in-coupled pump radiation must propagate relatively long distances along the optical resonator axis, possibly using reflective containment cell walls. Taken together then, the end-pump configuration requires the use of a diode pump source with extraordinarily high brightness.

Third, as one increases the diameter of a capillary end-pumped DPAL or the waveguide height in a waveguide end-pumped DPAL to scale the emitted output power, transverse thermal gradient values scale with the characteristic dimension. At some point, the thermal gradients become large enough to cause unacceptable thermal focusing of the output beam. Also, as mentioned above, the end area aspect ratio becomes too large.

Accordingly, several embodiments of the present invention overcome one or more of the limitations of the end-pumped DPAL, enabling the increase of diode-pumped gas-vapor laser (such DPAL) output power by one or more orders of magnitude higher than practically realizable with the end-pump type DPAL, while preserving high beam quality at the same time. For example, in some embodiments, the DPAL output power is scaled to at least 1 kW and up to many tens of kilowatts and beyond while preserving high beam quality.

According to some embodiments, a DPAL architectural configuration is provided that comprises: 1) a laser chamber (e.g., to be configured as an oscillator or amplifier) having a volume therein and with a defined optical axis; 2) an alkali-buffer vapor-gas medium flowing in a direction nominally transverse to the optical axis; and 3) one or more diode pump arrays whose radiation is directed into the flowing vapor-gas medium in a direction that is simultaneously nominally transverse to the optical axis and to the direction of the flowing laser medium.

According to some embodiments, gas-vapor (such as an alkali vapor), diode pumped lasers, and related methods of lasing, are provided including one or more of the following features: 1) the gas-vapor medium flows through a volume of a laser chamber (e.g., forming an optical resonator or an amplifier); 2) the direction of flow of the gas-vapor medium is transverse to an optical axis of the resonator; 3) the cavity is side-pumped by the one or more diode arrays or a laser pump source; 4) the direction of radiation from one or more diode arrays is transverse to the one or both of the direction of gas-vapor flow and the optical axis of the chamber.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object of some embodiments is to provide a diode pumped gas-vapor (such as an alkali vapor) configuration that produces output powers of at least 1 kilowatt (kW) and up to 5 kW, up to 10 kW, up to 100 kW, up to 1 MW, up to 5 MW with high beam quality. In some embodiments, high beam quality is defined in terms of M² values, where an M² value is a well understood metric in the art for beam quality and is often referred to as a beam quality factor, where an M² value of 1 is ideal. By way of example, see Siegman et al., “Output Beam Propagation and Beam Quality from a Multimode Stable-Cavity Laser”, IEEE Journal of Quantum Electronics, Vol. 29, No. 4, April 1993, which is incorporated herein by reference, for a description of M² values. In some embodiments, high beam quality is defined as having an M² value of less than 5. In other embodiments, the M² value is less than 3 and in some embodiments, the M² value is less than 2.

Another object of some embodiments is to provide a diode pumped gas-vapor (such as a alkali vapor) configuration that greatly reduces the demand brightness of diode pump arrays compared to that demanded in an end-pumped DPAL of comparable output power.

Another object of some embodiments is to provide a diode pumped gas-vapor (such as an alkali vapor) configuration that avoids the need to fabricate optical resonator end mirrors with simultaneously high reflectivity at the output wavelength and high transmission at the pump wavelength.

Other objects and advantages of several embodiments will become apparent to the reader and it is intended that these objects and advantages are within the scope of at least some embodiments of the present invention.

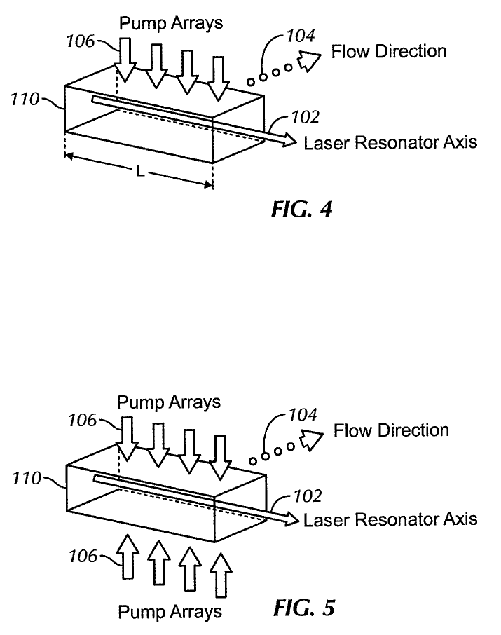

Referring first to FIG. 4, a simplified view is shown of one embodiment of a diode pumped gas-vapor laser in a triply-transverse configuration in which a direction of gas-vapor medium flow 104 is transverse to a laser resonator axis (generically referred to as an optical axis or laser axis 102), both of which are transverse to the direction of diode pump radiation 106 entering a cavity formed within a chamber 110 (also referred to as a laser head or cell) through which the gas-vapor medium flows.

The chamber 110 forming the cavity or volume therein is a solid structure having walls or windows, some of which are at least partially transmissive to the wavelengths of interest. In one form, an optical window at each end of the chamber is transparent to the laser wavelength allowing laser emission to enter and exit the chamber along a laser resonator axis. When used as an oscillator, mirrors (not shown in FIG. 4, one or more of which is partially transmitting) are located outside of the chamber 110 at each end to form the resonator. Alternatively, in some embodiments, a mirror is formed on a surface of the chamber. In the illustrated embodiment, a diode pump array is located proximate to a side of the chamber 110 and provides pump radiation in a side-pumping configuration. The gas-vapor medium is flowed through the chamber 110, for example, via inlets and outlets (not shown in FIG. 4), such as by using manifolds that may include flow conditioning devices, such as screens or honeycomb structures to evenly distribute the flow of the medium about the length L of the chamber 110. By flowing the medium, waste heat deposited in the medium is convected out of the chamber. A pump (not shown in FIG. 4) is used to cause the medium to flow. In some embodiments, the gas-vapor medium is flowed through a heat exchanger (not shown in FIG. 4) after exiting the chamber. It is noted that while FIG. 4 is shown in schematic form, one or ordinary skill in the art understands the physical components needed to affect the illustrated arrangement.

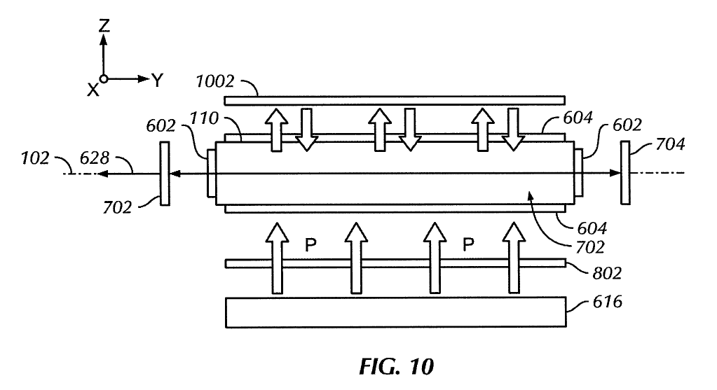

In a variant of this configuration (single-sided pumping), a mirror may be placed facing the pump array, on the opposite side of the optical axis, serving the purpose of reflecting the pump radiation not absorbed on the first pass back through the flowing gain medium for a second pass. An example of such an embodiment is illustrated in FIG. 10. In this variant, the additional mirror also tends to render more uniform the laser gain profile in the plane perpendicular to the optical axis. Such mirror may be formed on an interior surface of the cavity opposite the pump array or may be external to the cavity and on the opposite side of the cavity.

FIG. 5 shows another embodiment of the laser of FIG. 4 in which pump light or pump radiation 106 is directed into the chamber 110 on opposite sides, again facilitating a more uniform distribution of gain in the laser medium than is achievable in the scheme shown in FIG. 4. For example, diode arrays are placed on opposite sides of the chamber 110 from one-another. In the illustrated configurations of FIGS. 4 and 5, the vapor-gas laser medium is flowed through the laser chamber 110 (e.g., configured as an optical resonator or an amplifier) in a direction nominally transverse to the laser axis 102 of the chamber 110. Waste heat generated in the pump excited gain medium is convected out of the chamber, resulting in an approximated linear thermal gradient in the flow direction whose magnitude scales inversely with the flow velocity. The magnitude of the thermal gradient can therefore be reduced by increasing the flow velocity.

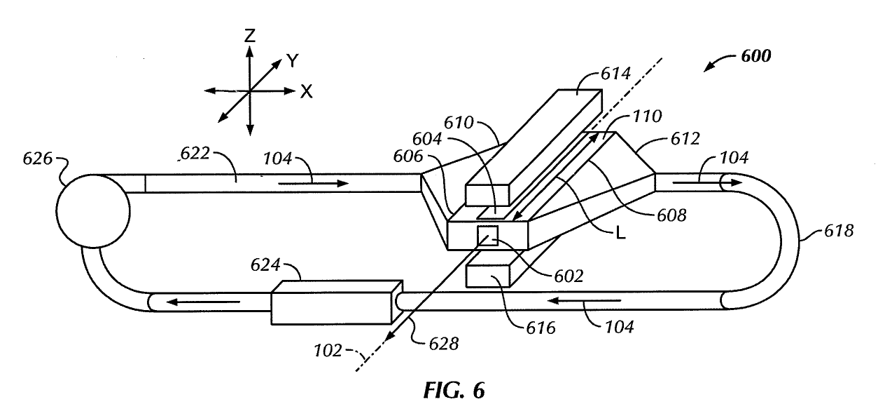

Referring next to FIG. 6, a perspective view is shown of a laser device 600 in accordance with several embodiments. The laser device 600 includes a chamber 110 having end windows 602, pump windows 604, a flow entrance 606, a flow exit 608, An entrance coupler 610 (which may also be referred to as a diffuser), an exit coupler 612 (which may also be referred to as an infuser), diode arrays 614 and 616 (which may be generically referred to as pump sources), conduit sections 618, 620 and 622, a heat exchanger 624 and a pump 626, which in operation provides a laser emission 628 (also referred to as a laser output) along the laser axis 102.

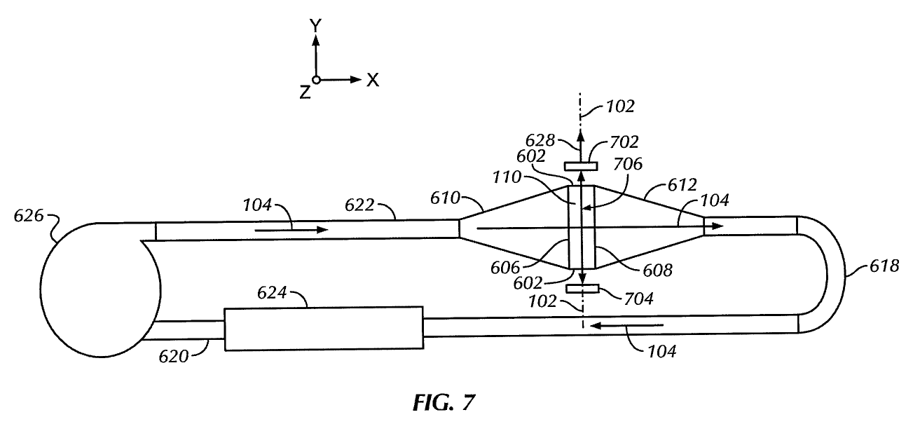

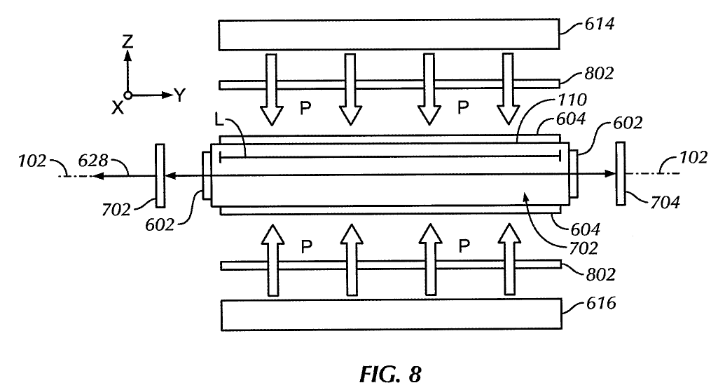

In the illustrated implementation, the chamber 110 takes the form of a solid structure, preferably made of a metallic material and includes the pump windows 604 that are at least partially transmissive to pump radiation or pump light from one or more pump sources (e.g., the diode arrays 614 and 616). The end windows 602 of the chamber 110 are at least partially transmissive to a laser emission resulting from operation of the laser device 600. In one form, the end windows 602 are at opposite ends of the long dimension or length L of the chamber 110 and are aligned along the laser axis 102. The laser chamber 110 also includes a volume (see FIGS. 7 and 8, for example) and the flow entrance 606 and the flow exit 608 that couple to the entrance coupler 610 and the exit coupler 612. The chamber 110 also includes the pump windows 604 on opposite surfaces of the side of the chamber 110 that are at least partially transmissive to the pump radiation provided by the diode arrays 614, 616. Thus, the configuration of the chamber 110, pump windows 604 and the diode arrays 614 is such that a pump source, e.g., the diode arrays 614, 616 will side pump the chamber 110. The diode arrays may include bars of semiconductor laser diodes. It is understood that the pump source may alternatively comprise pump sources other that laser diodes, such as a laser pump source, for example, a titanium sapphire laser.

The gas vapor gain medium flow 104 flows into the volume of the chamber via the entrance coupler 610 and the flow entrance 606, through the volume, and exits the volume via the flow exit 608 and the exit coupler 612. The gain medium flow is coupled via the conduit section 618 to the heat exchanger 624 to remove heat 110. The medium flow then flows via the conduit section 620 to the pump 626, which then pumps the medium flow back to the entrance coupler 610 via the conduit section 622. Thus, during operation, the gas-vapor medium is flowed through the chamber 110, heat is removed and then it is circulated back to the chamber 110. It is noted that in several embodiments, the entrance coupler 610 functions to transition the flowing gain medium from the cross sectional area, dimension and/or shape of the conduit section 622 to the cross sectional area, dimension and/or shape of the flow entrance 606 of the chamber 110. In some embodiments, the entrance coupler slows and spreads the flow to that desired through the volume of the chamber 110. In some embodiments, the entrance coupler 610 functions to or includes features to condition the flow of the gas-vapor medium to distribute the gas-vapor medium substantially uniformly along the length L of the chamber as it flows therethrough. Likewise, the exit coupler 612 functions to transition the flowing gain medium from the cross sectional area, dimension and/or shape of the flow exit 608 of the chamber 110 to the cross sectional area, dimension and/or shape of the conduit section 618. In some embodiments, the exit coupler slows and spreads the flow to that desired through the volume of the chamber 110. While the gas-medium vapor is flowed through the chamber 110, the diode arrays 604 and 616 provide optical pump radiation or pump light into the volume through coupling optics (not shown in FIG. 6, see FIG. 8) and the pump windows 604.

Referring next to FIG. 7, a top cutaway view is shown of one embodiment of the laser device of FIG. 6 additionally illustrating a volume 706 within the chamber 110 and mirrors 702 and 704 outside of the laser windows 602. When implemented as a resonator or oscillator, the laser device 600 includes the mirrors 702 and 704. In one form, each of mirrors 702 and 704 are slightly curved, the concave surface thereof facing the respective end window 602. Mirror 704 is designed to reflect substantially at least the entire wavelength of interest back into the volume 706. The mirror 702 is configured to partially reflect at least the entire wavelength of interest back into the volume 706 via the respective end window 602, and partially transmit at least the entire wavelength of interest therethrough for output to other components of a laser system. It is understood that the mirrors 702 and 704 may be implemented with the laser device 600 as illustrated in FIG. 6 (but have been omitted for clarity). A laser device 600 does not require the mirrors 702 and 704. When configured in a laser system without the mirrors, the laser device is in an amplifier configuration (see FIG. 13, for example). The physical components of the laser device 600 may be held in fixed relationship with each other using one or more frame or support structures and other mechanically coupling devices.

Referring next to FIG. 8, a side cutaway view of one embodiment of the laser chamber 110 is shown and which further illustrates pump coupling optics 802. Diode array 604 is positioned above the top pump window 604 and the diode array 616 is positioned below the bottom pump window 604. The pump light or pump radiation from the diode arrays 614 and 616 is focused toward and through the pump windows 604 by the pump coupling optics 802. The pump coupling optics 802 may include one or more optical elements. The end windows 602, the mirrors 702 and 704, and the laser emission 628 are also illustrated in the view of FIG. 8.

In the illustrated embodiments of FIGS. 4-8, the pump light or radiation 106 from the diode pump arrays (from either one array as shown in FIG. 4, or two diode arrays as show in FIGS. 5-8) is directed generally into the flowing gas-vapor gain medium in a direction nominally transverse to the flow direction 104 and nominally transverse to the optical axis 102 of the chamber. This side-pumping orientation of the pump flux (es) to the optical axis 102 means that the pump radiation does not have to pass through an end mirror (such as mirrors 702, 704) of the laser device. Thus, the end mirror reflection and transmission characteristics at the laser output wavelength can be set without regard to transmission and loss at the pump wavelength. This configuration also greatly relieves the demand brightness on the diode pump array (relative to a known end-pumped type DPAL), since the pump radiation may freely propagate through the gas-vapor gain medium without the need for reflective containment cell walls. When used as an amplifier, see FIG. 13, for example, it is understood that the laser chamber containing the gain medium is part of a train of optical elements including mirrors, lenses, gain mediums (one of which is a laser chamber used to amplify a laser emission directed therethrough), etc.

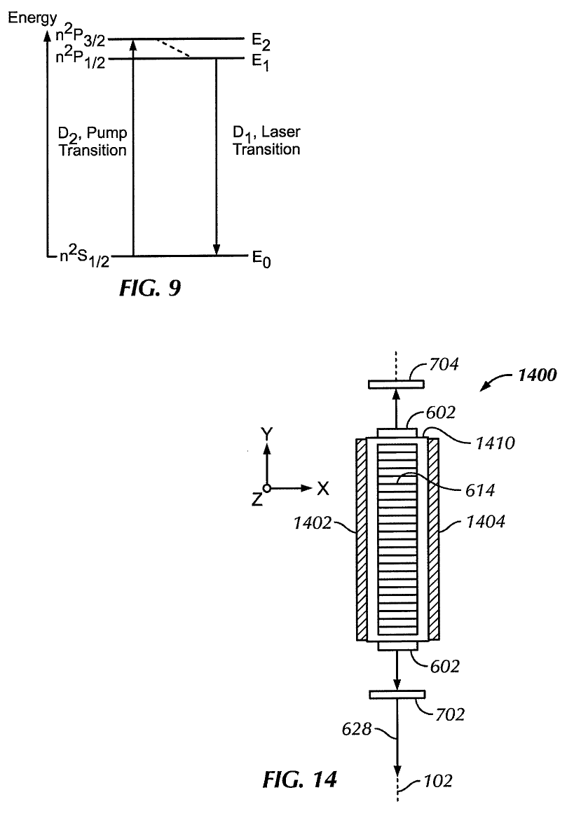

As described above, in accordance with many embodiments, the gain medium is a flowing gas-vapor mixture that is flowed through the laser chamber 110. In preferred embodiments, the gas-vapor medium comprises a mixture of at least one buffer gas and an alkali atomic vapor. In some embodiments, the alkali atomic vapor is selected from among, but not limited to, cesium (Cs), rubidium (Rb), potassium (K), sodium (Na), and lithium (Li). Furthermore, by way of example, in some embodiments, the at least one buffer gas comprises one or more the rare gases: xenon, argon, krypton, neon, helium and their isotopes; hydrogen and deuterium; and the small hydrocarbon molecular gases: propane, ethane, and methane and their deuterated analogues and all other isotopes. In these embodiments, the chamber provides an optical cavity resonant at a wavelength substantially matching the wavelength λ₁ of the D₁ transition of an alkali vapor. Additionally, the alkali atomic vapor has a second D₂ transition at wavelength λ2, where the at least one buffer gas has the dual purpose of collisionally broadening the D₂ transition and collisionally transferring excitation energy from the upper level of the D₂ transition to the upper level of the D₁ transition at a rate larger than the radiative decay rate of either of these levels. FIG. 9 illustrates the basic energy level scheme of the DPAL class of lasers. In many embodiments, only the three lowest lying electronic levels of the alkali atom are utilized, the ²S_{1/2} ground electronic level and the first two ²P electronic levels, ²P_{1/2} and ²P_{3/2} to form a pure three level laser. In FIG. 9, n stands for the principal quantum number for the ground configuration of each alkali atom (Cs: n=6; Rb: n=5; K: n=4; Na: n=3; Li: n=2). In the DPAL laser, the alkali atom gain medium is excited (pumped) at a wavelength matching the wavelength of the ²S_{1/2}-²P_{3/2} electric-dipole-allowed transition (conventionally called the D₂ transition). After kinetic relaxation of pump excitation to the excited ²P_{1/2} electronic level, laser emission takes place on the ²P_{1/2}-²S_{1/2} transition (conventionally called the D₁ transition). The energy splitting of the ²P electronic level, divided by the energy of the ²P_{3/2} level, is defined as the quantum energy defect, and is a measure of the minimum waste energy required to produce an excited ²P_{1/2} upper laser level excitation in a DPAL device.

It is understood that in other embodiments, other gas-vapor combinations may be used in accordance with the principles of several embodiments of the invention.

It is noted that in embodiments using an alkali-buffer medium, the pump lasers are configured to emit at a wavelength substantially matching the wavelength λ2 of the D₂ transition, and with an emission spectral width of at least 0.01 nm (FWHM, full wave at half maximum) for optically pumping the gain medium at the wavelength λ2 of the D₂ transition, including optical pumping in the Lorentzian spectral wings of the D₂ transition, generating laser emission output at wavelength λ1.

### EXAMPLE 1

### Characteristic Parameters of a Triply-Transverse DPAL

Table 1 provides a summary of typical device parameters of a triply-transverse diode pumped gas-vapor laser comprising an alkali-buffer medium, also referred to as a DPAL, in accordance with one embodiment of the present invention. By triply transverse, in this embodiment, all three of the directions of gain medium flow, the laser axis and the direction of pump radiation are substantially transverse with respect to one another. In this embodiment, the alkali atomic vapor comprises potassium.

TABLE 1
Key device parameters of a potassium, triply-transverse DPAL.

| Parameter | Value | Units |
|---|---|---|
| Alkali number density | 2.5 × 10¹³ | atoms/cm³ |
| Helium pressure | 1 | atm |
| Pump transition effective cross-section*, σ_{eff} | 8 × 10⁻¹⁴ | cm |
| Small-signal pump absorption coefficient | 2 | cm² |
| Transverse pump dimension | 10 | cm⁻¹ |
| Small signal, single-pass pump absorbance | 20 | |
| Average pump flux | 3 | kW/cm² |
| Bleachwave velocity | 4.7 × 10⁸ | cm/sec |
| Bleachwave thickness | 0.5 | cm |
| Bleachwave transit time | 21 | nsec |

In this embodiment, the demand pump array flux is a few kW/cm² compared with a pump array demand pump flux of many tens of kW/cm² for the conventional “end-pumped” configuration. In comparison, the demand pump array flux in a conventional end-pumped DPAL is typically greater than 20 to 30 kW/cm². Thus, in accordance with some embodiments in which the diode arrays 614, 616 side pump the chamber, demand pump array flux is less than 5 kW/cm², while in other embodiments, the demand pump array flux is less than 3 kW/cm². It is understood that variance of other parameters can result in different values. Moreover the output area of this embodiment (e.g., the area of the end window at one end of the chamber) is 100 cm² compared to a power-scaling-limited end-pumped DPAL of perhaps a few cm², giving rise to a correspondingly higher output power from the triply-transverse DPAL.

Several embodiments also provide the ability to operate at higher power and/or with a larger aperture area at the laser window 602. For example, according to applicants knowledge, non-flowing, end-pumped DPALs have only been demonstrated to operate at about 20 watts with an aperture area of about 1 mm. In contrast, a flowing gas-vapor DPAL that is side pumped as in some embodiments described herein can operate at a power of greater than 1 kW and up to 5 kW. In other embodiments, the output power is greater than 1 kW and up to 10 kW, up to 100 kW, up to 1 MW, or up to 5 MW depending on various parameters and configuration. This power will eventually be limited by parasitic issues. Similarly, such flowing medium DPALs can be implemented where the aperture area of the laser emission at the laser window 602 is greater than 0.1 cm² and up to 1 cm². In alternative embodiments, the aperture area of the laser emission at the laser window 602 is greater than 0.1 cm² and up to 10 cm², up to 100 cm² or up to 500 cm² depending on various parameters and configuration.

Accordingly, described herein are diode pumped gas-vapor lasers that are capable of being scaled to high power. Applicants believe that one of ordinary skill in the art would be skeptical that scaling a conventional gas-vapor laser, such as a DPAL, to high power would work. Additionally, applicants believe that due to the absorption lengths involved, one of ordinary skill in the art understands end-pumping to be practical as demonstrated in the art (for example, as described in U.S. Pat. No. 6,643,311, U.S. Pat. No. 7,061,958 and U.S. Pat. No. 7,061,960), but would be skeptical that the side-pumping of a gas-vapor laser, such as a DPAL, would be effective. This follows from the fact that generally it is necessary to have a diode pump absorption length of several centimeters in order to ensure efficient absorption. A conventional cell designed for end pumping does not have a sufficient transverse length to efficiently absorb a transverse (side pumping configuration) diode pump.

Referring next to FIG. 10, one embodiment of the laser device of FIGS. 6-8 is illustrated in which the chamber 110 is pumped by a pump source on one side of the chamber (i.e., a single side pumping configuration). That is, pump light is provided by diode array 616 and directed into the volume 702 via the pump coupling optics 802 and the pump window 604. A mirror 1002 is located at an opposite side of and external to the chamber 110. The mirror 1002 reflects pump radiation not absorbed on a first pass through the volume 702 back to the volume 702 through the flowing gain medium for a second pass. In this embodiment, the mirror 1002 also tends to render more uniform the laser gain profile in the plane perpendicular to the optical axis 102. In an alternative embodiment, the mirror 1002 may be formed on an interior surface of the chamber opposite the pump array, for example, the mirror be formed on an inner surface of the chamber at the location of the top pump window 604.

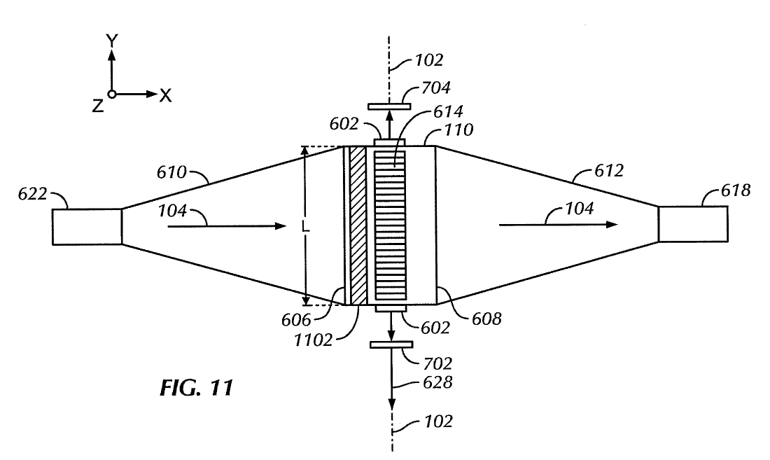

Referring next to FIG. 11, an embodiment of the laser device of FIG. 7 is illustrated in accordance with several embodiments. In this embodiment, the entrance coupler 610 includes a flow conditioner 1102 located at the flow entrance 606. In preferred embodiments, the flow conditioner 1102 is used to ensure substantially uniform flow and distribution of the flowing gas-vapor medium along the length L and height of the chamber, or at least that portion of the length and height of the volume where the laser emission and the pump radiation intersect. The flow conditioner may be any known device to accomplish these functions and may include a screen, honeycomb structure, or vane structure, for example. The flow conditioner 1102 may also serve to provide a substantially uniform flow rate along the length and height of the chamber 110.

It is noted that although many of the illustrated embodiments describe generally rectangular prism or cuboid shaped laser chambers, other geometries may be used without departing from the scope of the invention. For example, rectangular parallelepiped, prism shaped, circular or oval cylinder shaped chambers may be employed in some embodiments.

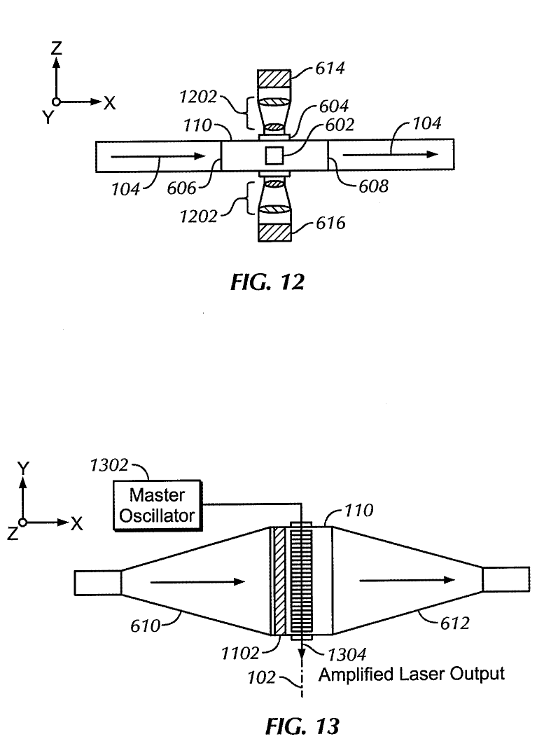

Referring next to FIG. 12, a side end view is show of one embodiment of the laser device of FIGS. 6-8 illustrating the laser window 602 and one embodiment of the pump coupling optics 1202. In this embodiment, the pump coupling optics each comprise two optical elements. Additionally, it is noted that in some embodiments, when referring to the aperture size achievable in some embodiments, the aperture size refers to the output area of the output laser beam (or laser emission) exiting a surface (e.g., the laser window 602) of the chamber. It is generally understood that the area (or envelope) of the output laser beam will fit within the area of the laser window 602. In preferred embodiments, the laser window 602 is designed such that the output area of the laser beam fills most of the area of the laser window 602.

Referring next to FIG. 13, an embodiment of the laser device of FIGS. 6-8 configured as a laser amplifier is shown. In this embodiment, mirrors are not provided. Instead, a master oscillator 1302 provides a laser emission that is directed along the laser axis 102 through the chamber 110. The laser chamber outputs an amplified output 1304 or laser emission which is directed to other components of the system. For example, in some embodiments, the laser output is directed through multiple stages of similar laser chambers configured as laser amplifiers. It is noted that in some embodiments, the master oscillator may comprise a laser chamber such as described herein including the mirrors 702 and 704 and configured as a resonator or oscillator.

The following are some variations to the embodiments described thus far. In some embodiments, the gas-vapor laser chamber is side pumped, but the gas-vapor medium is static and does not flow through the laser chamber. One example of such a configuration is illustrated in FIG. 14. In this embodiment, a laser device 1400 includes a laser chamber 1410 having a volume formed therein and statically containing a gas-vapor gain medium as described herein. Similar to flowing embodiments, the laser device 1400 also includes one or more diode arrays 614, 616 or other pump sources, pump windows, laser windows 602, and when configured as a resonator, mirrors 702 and 704. However, in contrast to the flowing embodiments described herein, there are no flow entrance or flow exit. The sides of the laser chamber 1410 are enclosed. Preferably, heat removal features are included to conduct away heat generated within the chamber 1410. For example, as illustrated, convective heat sinks 1402 and 1404 are positioned against the exterior surfaces of the laser chamber 1410. Alternatively, other conventional heat removing means could be used to remove heat from the chamber 1410, such as cold plates, micro channel coolers, etc.

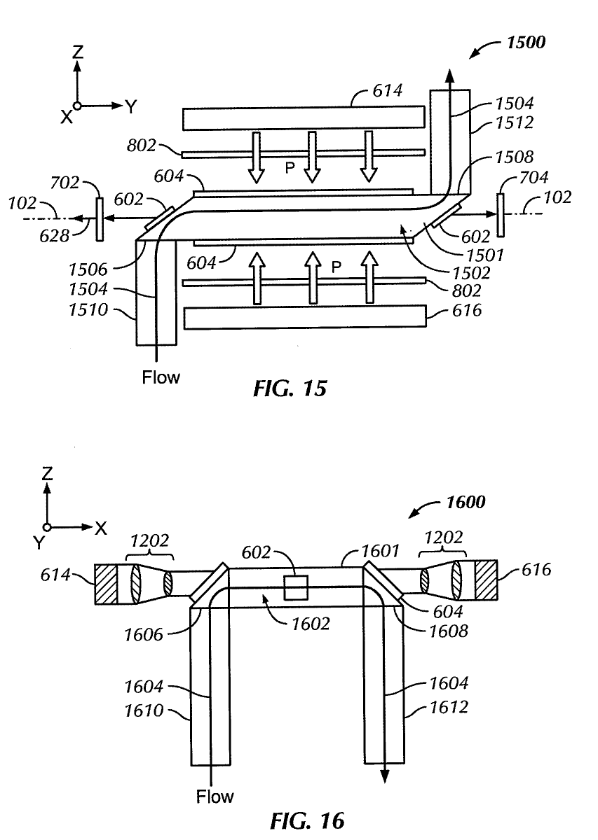

In other embodiments, the gas-vapor laser flows, but in a direction not transverse to the laser axis, e.g., it flows about the laser axis 102. FIG. 15 illustrates such an embodiment. That is, FIG. 15 illustrates a laser device 1500 including a laser chamber 1501 having a volume 1502 formed therein. A flow entrance 1506 is located at a bottom surface of one end of the chamber 1501, while a flow exit 1508 is located at a top surface of an opposite end of the chamber 1501. It is noted that the location of the flow entrance 1506 and the flow exit 1508 is for illustrative purposes; thus, one or both of the flow entrance 1506 and the flow exit 1508 may be implemented on different surfaces. An entrance coupler 1510 is coupled to the flow entrance 1506 and directs the flowing gas-vapor gain medium 1504 into the chamber 1501, which flows substantially along the laser axis 102 while within the chamber 1501. The flowing gas-vapor gain medium 1504 then exits the chamber via the flow exit 1508 and the exit coupler 1512. Although not illustrated, it is understood that the flow may be circulated through a heat exchanger and pumped back into the entrance coupler 1510. As other embodiments described herein, the diode arrays 614 and 616 pump optical pump radiation into the chamber 1501 via the pump coupling optics 802 and pump windows 602. When configured as a resonator, the mirrors 702 and 704 are employed. In this embodiment, the end walls of the chamber 1501 are oriented at an angle in order to provide a smooth flow transition as the flowing gas-vapor gain medium 1504 is introduced into and exits the volume 1502. Accordingly, in one embodiment, the chamber 1501 has a rectangular parallelepiped shape. One of ordinary skill in the art can easily vary the illustrated structure and arrangement without departing from the scope of several embodiments of the invention.

In other embodiments, the direction of diode side-pumping is not transverse to the direction of flow, e.g., the direction of diode side-pumping is along the same axis as the direction of medium flow. This results in the thermal gradients in the gain medium being parallel to the optical axis, reducing transverse optical aberrations. FIG. 16 illustrates such an embodiment. That is, FIG. 16 illustrates a laser device 1600 including a laser chamber 1601 having a volume 1602 formed therein. A flow entrance 1606 is located along a bottom edge of side of a length of the chamber 1601, while a flow exit 1608 is located along a bottom edge of an opposite side of the length of the chamber 1601. An entrance coupler 1610 is coupled to the flow entrance 1606 and directs the flowing gas-vapor gain medium 1604 into the chamber 1601, which flows substantially transverse to the laser axis 102 while within the chamber 1601. The flowing gas-vapor gain medium 1604 then exits the chamber via the flow exit 1608 and the exit coupler 1612. Although not illustrated, it is understood that the flow may be circulated through a heat exchanger and pumped back into the entrance coupler 1610. In this embodiment, the diode arrays 614 and 616 provide pump radiation along the same axis as the flow of the gas-vapor gain medium. That is, the diode arrays 614 and 616 are located to direct pump radiation through pump windows 604 formed in the side walls of the length of the chamber 1501. As other embodiments described herein, the diode arrays 614 and 616 pump optical pump radiation into the chamber 1501 via the pump coupling optics 1202 and the pump windows 602. When configured as a resonator, the mirrors (not illustrated in this view) are employed. In this embodiment, the side walls of the chamber 1501 along its length that contain the pump windows 604 are oriented at an angle in order to provide a smooth flow transition as the flowing gas-vapor gain medium 1604 is introduced into and exits the volume 1602. Accordingly, in one embodiment, the chamber 1501 has a prism shape. One of ordinary skill in the art can easily vary the illustrated structure and arrangement without departing from the scope of several embodiments of the invention.

It is noted that in some embodiments, the gas-vapor gain medium is flowed through the volume of the laser chamber at an angle offset from transverse (i.e., perpendicular) to one or both of the laser axis 102 and the pump direction. That is, one or more of the entrance coupler, the flow entrance, shape of the chamber walls, the flow exit and the exit coupler may be configured to direct the flowing gain medium through the volume at an angle other than substantially transverse to one or both of the laser axis and the pump axis. Such an angle may be any angle between 1 and 89 degrees depending on the implementation. However, in preferred form, the gain medium is flowed through the volume at an angle that is substantially transverse to one or both of the laser axis and the pump axis. For example, in some embodiments, such an angle may be within 5 degrees of being exactly transverse.

In some embodiments, a gas-vapor laser is defined in terms of its output and/or performance characteristics, rather than in terms of its physical configuration. For example, in one embodiment, a gas-vapor (such as an alkali-buffer medium) laser is provided that is capable of high power operation of described herein can operate at a power of greater than 1 kW and up to 5 kW with high beam quality. In other embodiments, the output power is greater than 1 kW and up to 10 kW, up to 100 kW, up to 1 MW, or up to 5 MW with high beam quality depending on various parameters and configuration. This power will eventually be limited by parasitic issues. In some embodiments, high beam quality is defined in terms of M² values (a value of beam quality factor), which are a well understood metric in the art for beam quality, where an M² value of 1 is ideal. For example, in some embodiments, high beam quality is defined as having an M² value of less than 5. In other embodiments, the M² value is less than 3 and in some embodiments, the M² value is less than 2. In another embodiment, a gas-vapor (such as an alkali-buffer medium) laser is provided that is capable of operating such that an output aperture area of the laser emission exiting the chamber at a surface is greater than 0.1 cm² and up to 1 cm² with high beam quality, the surface being the portion or window of the laser chamber through which a laser emission exits the chamber or cell. In alternative embodiments, the aperture area of the laser emission at the laser window 602 is greater than 0.1 cm² and up to 10 cm², up to 100 cm² or up to 500 cm² with high beam quality depending on various parameters and configuration. In a further embodiment, a gas-vapor laser is provided that is capable of operating with high beam quality in which the laser diode pump flux is less than 20 kW/cm², and preferably, less than 10 kW/cm², less than 5 kW/cm², or less than 3 kW/cm². Performance characteristics such as described herein are understood to be the result of the interaction of at least the physical configuration and dimensions of the laser device, optical design of the system (including coupling optics and mirrors), temperature of the system, the gain medium used, flow characteristics, pump source characteristics, etc.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Reference throughout this specification to “one embodiment,” “an embodiment,”, “several embodiments”, or similar language means that a particular feature, structure, or characteristic described in connection with the embodiment or embodiments is included in at least one embodiment of the present invention. Thus, appearances of the phrases “in one embodiment,” “in an embodiment,” “in several embodiments”, and similar language throughout this specification may, but do not necessarily, all refer to the same embodiment or embodiments.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An alkali vapor laser, comprising:
a laser chamber having a volume formed therein;
a gain medium flowing through said volume in a direction substantially transverse to an optical axis of said volume, said gain medium comprising a mixture of at least one buffer gas and said alkali atomic vapor, said alkali atomic vapor having a D₁ transition at wavelength λ₁ and a D₂ transition at wavelength λ2, wherein said at least one buffer gas has the dual purpose of collisionally broadening said D₂ transition and collisionally transferring excitation energy from the upper level of said D₂ transition to the upper level of said D₁ transition at a rate larger than the radiative decay rate of either of these levels; and
a pump laser, emitting at a wavelength substantially matching the wavelength λ2 of said D₂ transition, with an emission spectral width of at least 0.01 nm (FWHM) for optically pumping said gain medium at the wavelength λ₂ of said D₂ transition of said alkali atomic vapor, including optical pumping in the Lorentzian spectral wings of said D₂ transition, emitting laser emission output at wavelength XI; said pump laser propagating its pump radiation into said gain medium in a direction substantially transverse to the optical axis of said volume and also substantially transverse to the flow direction of said gain medium.

2. The laser of claim 1 wherein the alkali atomic vapor comprises atoms selected from one or more of cesium, rubidium, potassium, sodium, and lithium.

3. The laser of claim 1 wherein said at least one buffer gas is selected from one or more of the rare gases: xenon, argon, krypton, neon, helium and their isotopes; hydrogen and deuterium; and the small hydrocarbon molecular gases: ethane, methane, propane and their deuterated analogues and all other isotopes.

4. The laser of claim 1 wherein the laser chamber is used as a laser resonator or a laser amplifier.

5. A method of lasing comprising:
flowing an alkali-buffer vapor-gas gain medium through a volume of a laser chamber transverse to an optical axis of the chamber;
pumping the flowing gain medium transversely to a flow direction and transversely to the optical axis of the chamber, producing optical gain in the vapor-gas gain medium; and
extracting laser output power in a direction parallel to the optical axis of the chamber, and in a direction transverse to the flow direction and the direction of optical pumping.

6. A laser device comprising:
a laser chamber having a volume formed therein;
a gain medium within the volume and comprising a gas and vapor mixture; and
a pump source oriented to side pump optical pump radiation along a pump direction into the volume;
wherein responsive to the optical pump radiation, a laser emission from the gain medium passes through the volume along a laser axis.

7. The device of claim 6 wherein the vapor comprises an alkali atomic vapor.

8. The device of claim 7 wherein the alkali atomic vapor comprises atoms selected from one or more of cesium, rubidium, potassium, sodium, and lithium.

9. The laser of claim 7 wherein the gas comprises a gas selected from one or more of the rare gases: xenon, argon, krypton, neon, helium and their isotopes; hydrogen and deuterium; and the small hydrocarbon molecular gases: ethane, methane, propane and their deuterated analogues and all other isotopes.

10. The device of claim 6 wherein the laser chamber comprises a flow entrance and a flow exit and the gain medium flows through the volume along a flow direction via the flow entrance and the flow exit.

11. The device of claim 10 wherein the flow direction is substantially transverse to the laser axis.

12. The device of claim 10 wherein the pump direction is substantially transverse to the laser axis.

13. The device of claim 10 wherein the laser axis, the flow direction and the pump direction are substantially transverse to each other.

14. The device of claim 10 wherein the flow direction is along a same axis as a pump direction.

15. The device of claim 10 wherein the flow direction is along the laser axis.

16. The device of claim 10 further comprising a flow conditioner proximate the flow entrance.

17. The device of claim 6 wherein the gain medium is statically contained within the volume.

18. The device of claim 6 wherein the pump source comprises a diode pump laser.

19. The device of claim 6 wherein the laser emission has a power of at least 1 kW and up to 5 MW.

20. The device of claim 6 wherein the laser emission exits the laser chamber via a surface of the laser chamber, the laser emission having an output area at the surface of at least 0.1 cm² and up to 500 cm².

21. The device of claim 6 wherein the pump source provides the optical pump radiation with a pump flux of less than 20 kW/cm².

22. The device of claim 6 wherein the laser emission has a beam quality having an M² value of less than 5.

23. A method of lasing comprising:
pumping a gain medium within a volume of a laser chamber with optical pump radiation along a pump direction in a side-pumping configuration, the gain medium comprising a gas and vapor mixture;
producing optical gain in the gain medium; and
extracting laser output power in a direction parallel to an optical axis of the chamber.

24. The method of claim 23 wherein the vapor comprises an alkali atomic vapor.

25. The method of claim 24 wherein the alkali atomic vapor comprises atoms selected from one or more of cesium, rubidium, potassium, sodium, and lithium.

26. The method of claim 24 wherein the gas comprises a gas selected from one or more of the rare gases: xenon, argon, krypton, neon, helium and their isotopes; hydrogen and deuterium; and the small hydrocarbon molecular gases: ethane, methane, propane and their deuterated analogues and all other isotopes.

27. The method of claim 23 further comprising:
flowing the gain medium through the volume of the chamber along a flow direction.

28. The method of claim 27 wherein the flow direction is substantially transverse to the optical axis.

29. The method of claim 27 wherein the pump direction is substantially transverse to the optical axis.

30. The method of claim 27 wherein the optical axis, the flow direction and the pump direction are substantially transverse to each other.

31. The method of claim 27 wherein the flow direction is along a same axis as a pump direction.

32. The method of claim 27 wherein the flow direction is along the laser axis.

33. The method of claim 27 further comprising conditioning the flowing gain medium prior to the flowing the gain medium through the volume.

34. The method of claim 23 wherein the pumping step comprises pumping the gain medium within the volume of the laser chamber with optical pump radiation, the gain medium statically contained within the volume.

35. The method of claim 23 wherein the extracting step comprises extracting the laser output power at a power of at least 1 kW and up to 5 MW.

36. The method of claim 23 wherein the extracting step comprises extracting the laser output power from a surface of the laser chamber such that a laser emission at the surface has an output area of at least 0.1 cm² and up to 500 cm².

37. The method of claim 23 wherein the pumping step comprises pumping the gain medium within the volume of the laser chamber with optical pump radiation having a pump flux of less than 20 kW/cm².

38. The method of claim 23 wherein the extracting step comprises extracting the laser output power in a laser emission having a beam quality having an M² value of less than 5.

39. A laser device comprising:
a laser chamber having a volume formed therein;
a gain medium within the volume and comprising a gas and vapor mixture; and
a pump source oriented to provide optical pump radiation along a pump direction into the volume;
wherein responsive to the optical pump radiation, a laser emission from the gain medium passes through the volume along a laser axis; and
wherein the laser emission has a power of at least 1 kW and up to 5 MW with a beam quality having an M² value of less than 5.

40. A laser device comprising:
a laser chamber having a volume formed therein;
a gain medium within the volume and comprising a gas and vapor mixture; and
a pump source oriented to provide optical pump radiation along a pump direction into the volume;
wherein responsive to the optical pump radiation, a laser emission from the gain medium passes through the volume along a laser axis; and
wherein the laser emission exits the laser chamber via a surface of the laser chamber, the laser emission having an output area at the surface of at least 0.1 cm² and up to 500 cm² and the laser emission having a beam quality having an M² value of less than 5.

41. A laser device comprising:
a laser chamber having a volume formed therein;
a gain medium within the volume and comprising a gas and vapor mixture; and
a pump source oriented to provide optical pump radiation along a pump direction into the volume;
wherein responsive to the optical pump radiation, a laser emission from the gain medium passes through the volume along a laser axis; and
wherein the pump source provides the optical pump radiation having a pump flux of less than 20 kW/cm² and the laser emission has a beam quality having an M² value of less than 5.
